(19) United States
(12) Patent Application Publication
(10) Pub. No.: US 2011/0215974 A1
(43) Pub. Date: Sep. 8, 2011

(54) MULTI-BAND ANTENNA APPARATUS OF PORTABLE TERMINAL

(75) Inventors: Jong In Lee, Hwaseong-si (KR); Jang Hwan Noh, Nam-gu (KR)

(73) Assignee: SAMSUNG ELECTRONICS CO., LTD., Suwon-si (KR)

(21) Appl. No.: 13/040,773

(22) Filed: Mar. 4, 2011

(30) Foreign Application Priority Data
Mar. 5, 2010 (KR) 10-2010-0019646

(51) Int. Cl. H01Q 21/30; H01Q 1/24

(52) U.S. Cl. 343/702; 343/725

(57) ABSTRACT

A multi-band antenna apparatus of a portable terminal increases multi-band support and space utility by installing a broadcasting antenna in an installation space of a mobile communication antenna. The multi-band antenna apparatus includes a carrier engaging with a main circuit board of the portable terminal. A first antenna emitter is provided at one side of the carrier. A whip antenna including an outer sleeve is provided inside the carrier. A second antenna emitter electrically connected to an extension line is integrally extended from a first antenna emitter and an outer sleeve of a whip antenna. A first power supply line electrically connecting a first power supply pad is provided at the main circuit board to the first antenna emitter. And a second power supply line electrically connecting the outer sleeve of the whip antenna to a second power supply pad is provided at the main circuit board.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Mar. 5, 2010 and assigned Serial No. 10-2010-0019646, the entire disclosure of which is hereby incorporated by reference.

### TECHNICAL FIELD OF THE INVENTION

The present invention relates to a multi-band antenna apparatus of a portable terminal, and more particularly, to a multi-band antenna apparatus of a portable terminal by installing a broadcasting antenna in an installation space of a mobile communication antenna and connecting them to each other, thereby increasing multi-band and space utility.

### BACKGROUND OF THE INVENTION

A widely used portable terminal is a multi-function multimedia device that includes a voice and video call function, an information input/output function, and a data storing function.

In addition, the portable terminal provides various services as well as a communication service. Some examples of multimedia broadcasting service are Terrestrial Digital Multimedia Broadcasting (DMB), Digital Video Broadcasting-Handheld (DVB-H), Media Forward Link Only (FLO), and Advanced Television Systems Committee-Mobile/Handheld (ATSC-M/H).

A broadcasting antenna of a low band frequency is required so as to watch the multimedia broadcast.

A whip antenna configured by multi-stages of a cylindrical sleeve is a representative example of the broadcasting antenna.

The whip antenna is installed at a separate space other than an installation space of a mobile communication antenna.

An installation space of a mobile communication antenna is increasing to convert a band of a mobile communication antenna into a multi-band and a broadband such that it can use various frequency bands.

Furthermore, when the broadcasting antenna is additionally installed, space utility is significantly deteriorated in proportion thereto.

However, these go against a continuous trend for miniaturization and reducing the weight of a portable terminal.

### SUMMARY OF THE INVENTION

To address the above-discussed deficiencies of the prior art, it is a primary object to provide a multi-band antenna apparatus of a portable terminal by installing a broadcasting antenna in an installation space of a mobile communication antenna and connecting them to each other, thereby increasing multi-band support and space utility.

To achieve the object of the present invention, the present invention includes an antenna apparatus installed on a main circuit board, implementing a multi-band, and reducing an antenna installation space.

In accordance with an aspect of the present invention, a multi-band antenna apparatus of a portable terminal, includes a carrier engaging with a main circuit board of the portable terminal. A first antenna emitter is provided at one side of the carrier. A whip antenna including an outer sleeve is provided inside the carrier. A second antenna emitter electrically connected to an extension line is integrally extended from the first antenna emitter and the outer sleeve of the whip antenna. A first power supply line electrically connecting a first power supply pad is provided at the main circuit board to the first antenna emitter. And a second power supply line electrically connecting the outer sleeve of the whip antenna to a second power supply pad is provided at the main circuit board.

The present invention can increase space utility by installing a broadcasting antenna in a space of a communication antenna.

By connecting the communication antenna to the broadcasting antenna, the broadcasting antenna can be used as the communication antenna and the communication antenna can be used as a length component of the broadcasting antenna.

Accordingly, the length of the broadcasting antenna can be significantly reduced.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view that illustrates a portable terminal according to an embodiment of the present invention;

FIG. 2 is an exploded perspective view that illustrates a portable terminal according to an embodiment of the present invention;

FIG. 3 is an exploded perspective view that illustrates a lower surface of a portable terminal according to an embodiment of the present invention;

FIG. 4 is a perspective view that illustrates an antenna apparatus according to an embodiment of the present invention;

FIG. 5 is an exploded perspective view that illustrates an antenna apparatus according to an embodiment of the present invention;

FIG. 6a and FIG. 6b are enlarged sectional views that illustrate parts A and B of FIG. 5, respectively; and

FIG. 7a and FIG. 7b are enlarged sectional views that illustrate parts C and D of FIG. 5, respectively.

### DETAILED DESCRIPTION OF THE INVENTION

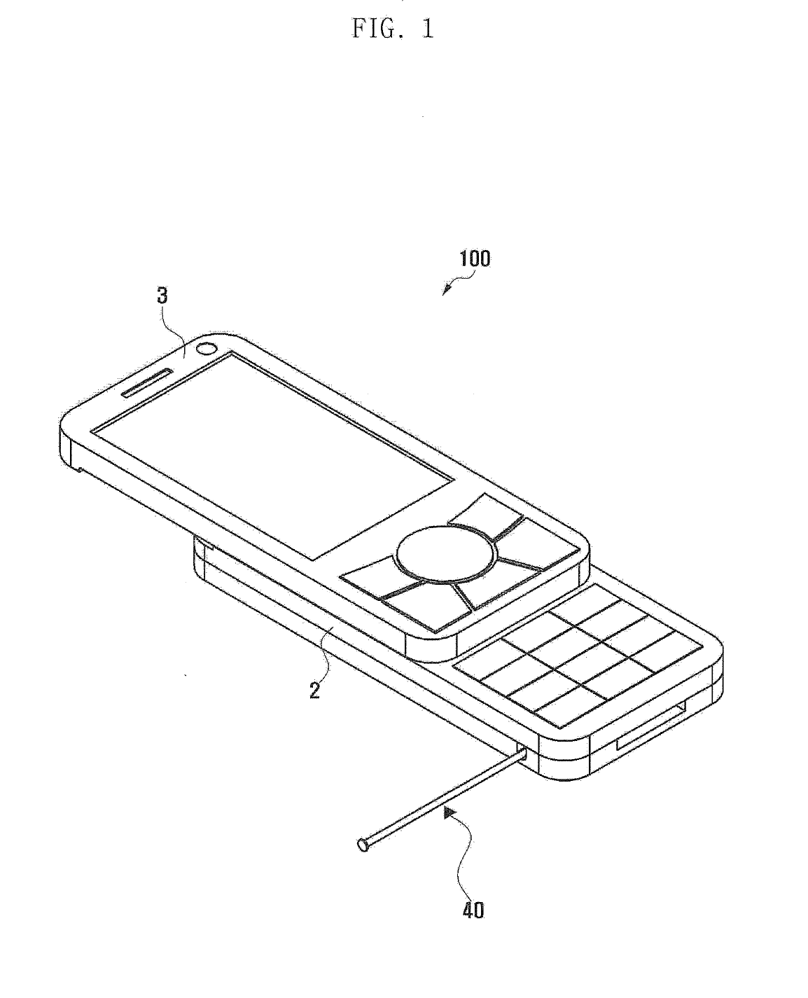

FIGS. 1 through 7b, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication device.

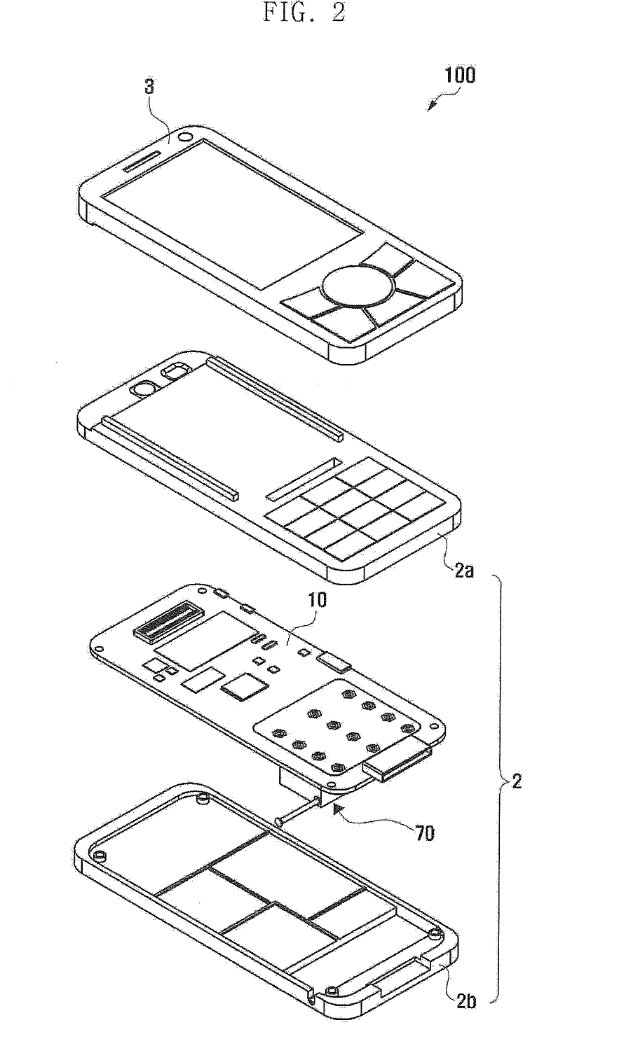

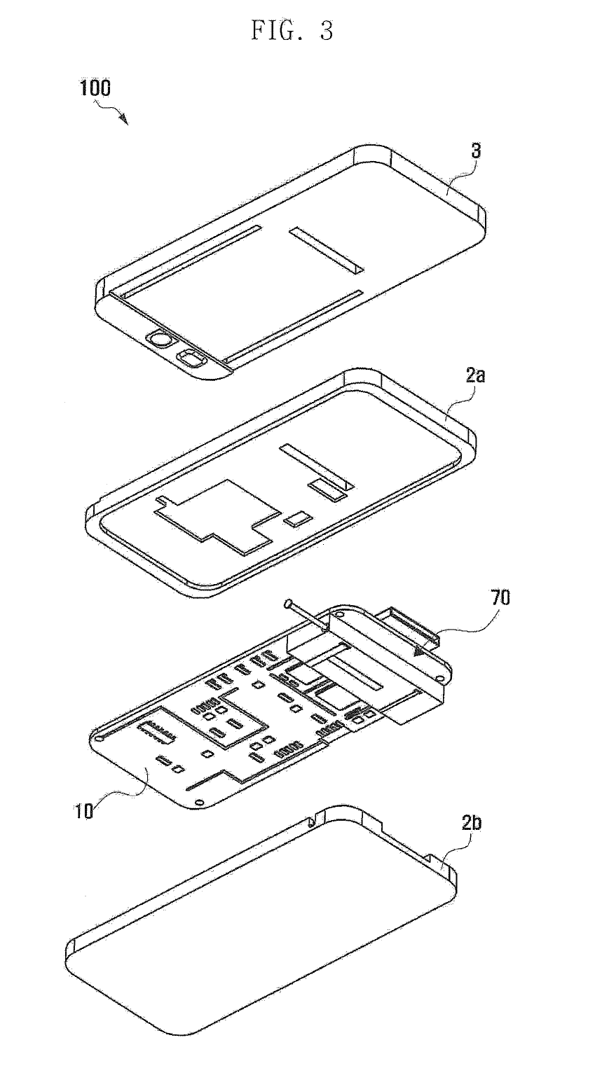

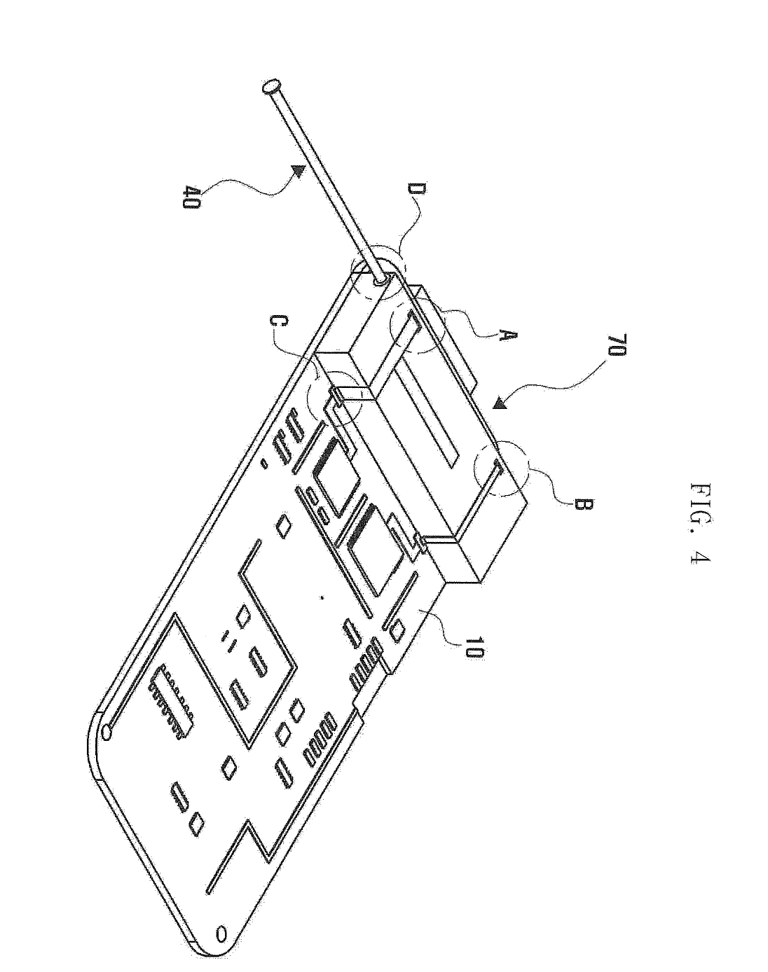

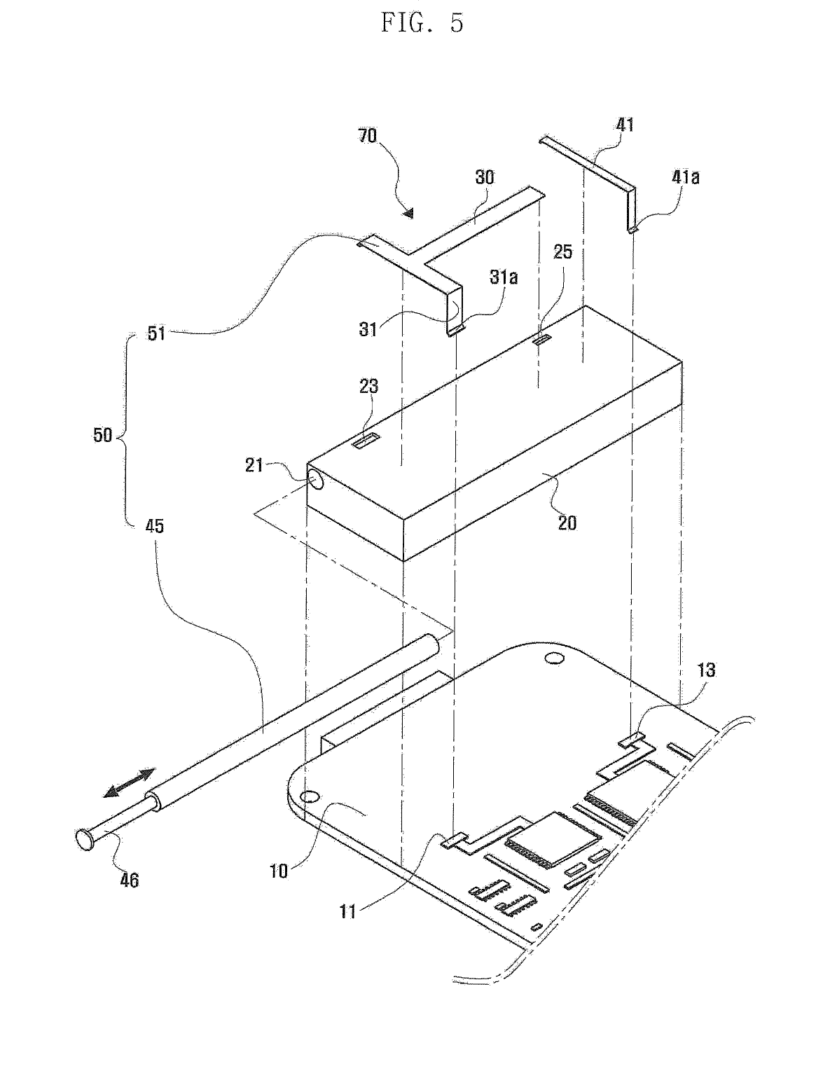

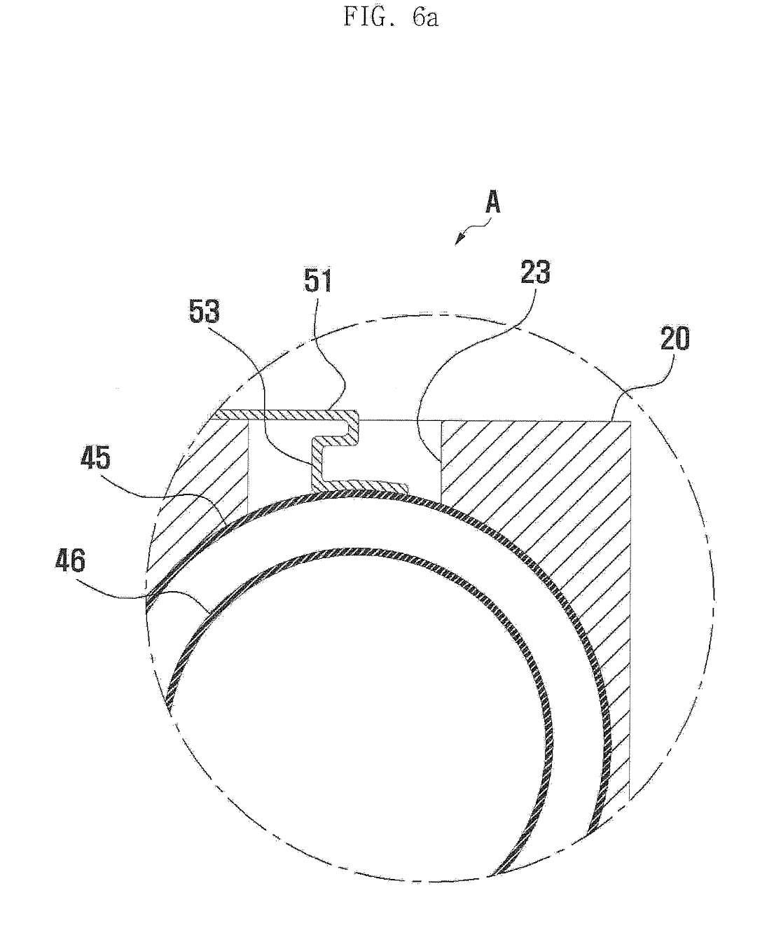

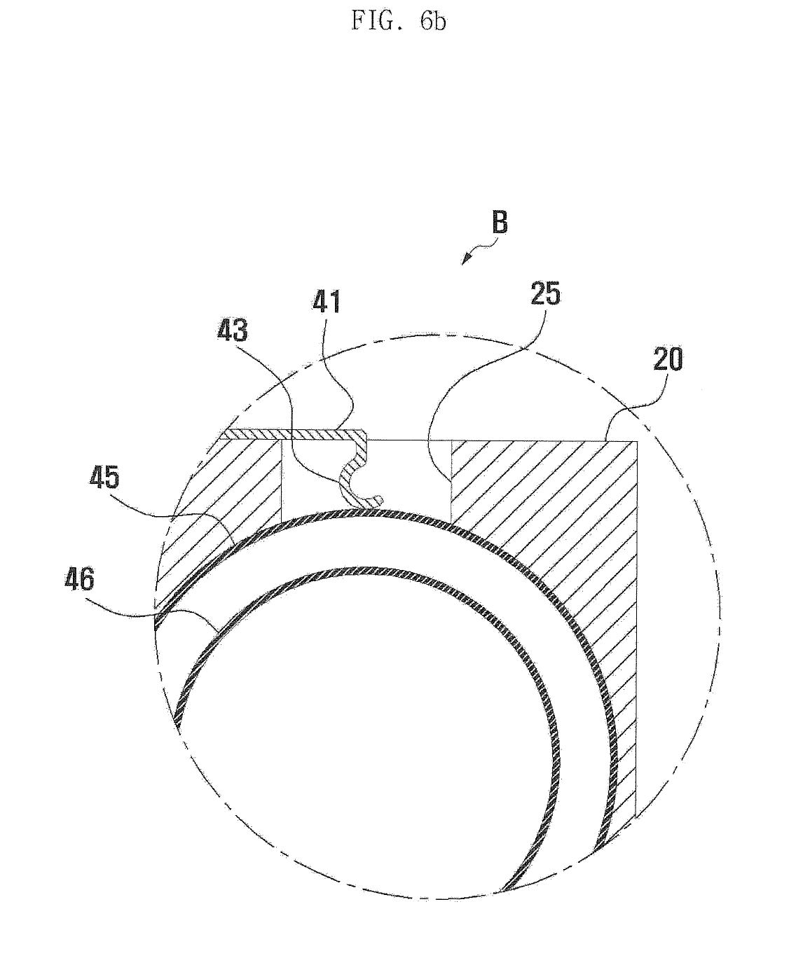

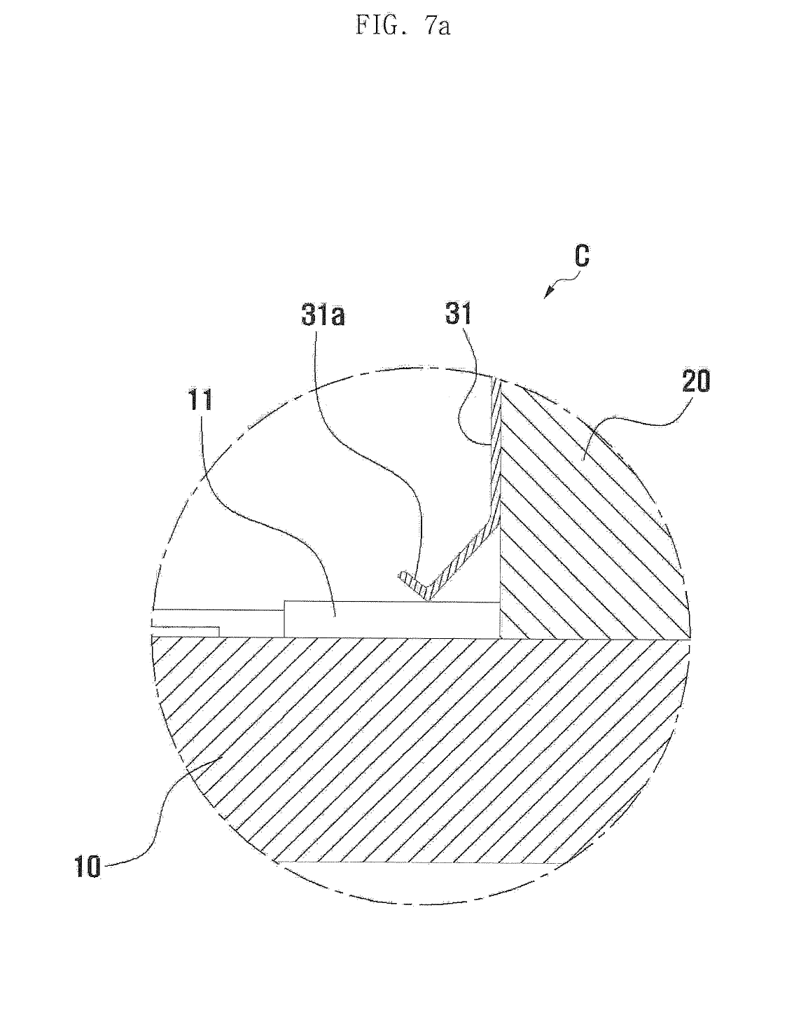

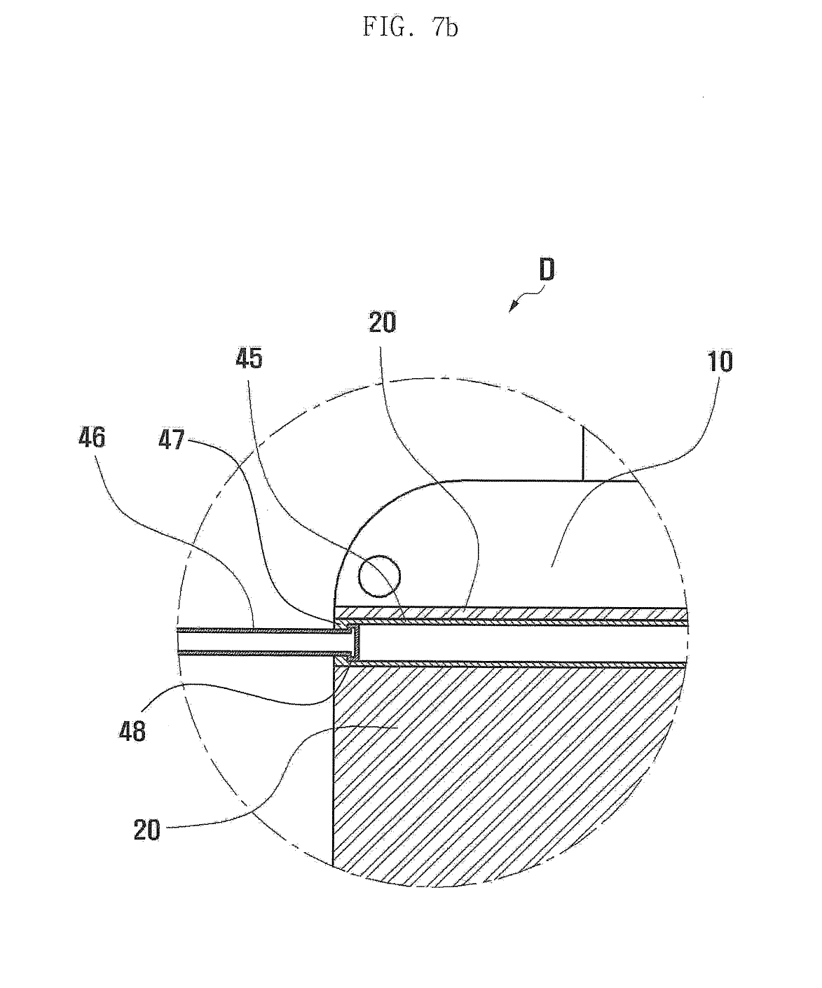

FIG. 1 is a perspective view that illustrates a portable terminal according to an embodiment of the present invention; FIG. 2 is an exploded perspective view that illustrates a portable terminal according to an embodiment of the present invention; FIG. 3 is an exploded perspective view that illustrates a lower surface of a portable terminal according to an embodiment of the present invention; FIG. 4 is a perspective view that illustrates an antenna apparatus according to an embodiment of the present invention; FIG. 5 is an exploded perspective view that illustrates an antenna apparatus according to an embodiment of the present invention; FIG. 6a and FIG. 6b are enlarged sectional views that illustrate parts A and B of FIG. 5, respectively; and FIG. 7a and FIG. 7b are enlarged sectional views that illustrate parts C and D of FIG. 5, respectively.

Referring to FIG. 1 to FIG. 5, the portable terminal 100 may include a folder type terminal or a slide type terminal. Hereinafter, for convenience of a description, it is assumed that the portable terminal is a slide type terminal.

A second antenna emitter 50 of the present invention is implemented using an outer sleeve 45 of a whip antenna 40, and the whip antenna 40 may significantly reduce a length of the whip antenna 40 by using the first antenna emitter 30.

A detailed description of the portable terminal will now be given.

A portable terminal 100 includes a main circuit board 10, a body 2, a slide unit 3, and an antenna apparatus 70.

An antenna device 70 of the present invention includes a carrier 20, a first antenna emitter 30, a whip antenna 40, and a second antenna emitter 50.

Referring to FIG. 4 and FIG. 5, the antenna apparatus 70 is provided at one side of the main circuit board 10, and the antenna apparatus 70 and the main circuit board 10 are provided inside the body 2. The body 2 is divided into an upper case 2a and a lower case 2b.

The carrier 20 is made by a dielectric material that includes a filled interior, and is provided at one side of the main circuit board 10. To prevent harm to a human body due to an electromagnetic wave and degradation, the carrier 20 is preferably provided at one surface, namely, a lower surface of the main circuit board 10 facing a lower case 2b in an installation direction of a keypad 2c for the body 2.

The first antenna emitter 30 is provided at another surface, namely, an upper surface of the carrier 20 opposite to one surface, namely, a lower surface thereof in which the carrier 20 engages with the main circuit board 10. The first antenna emitter 30 is formed by a metal plate. The first antenna emitter 30 engages with the carrier 20 by fusion.

The whip antenna 40 includes an outer sleeve 45 and an inner sleeve 46 inserted and extended into and from the outer sleeve 45.

Further, the whip antenna 40 is an internal antenna which is provided inside the carrier 20. The whip antenna 40 may be inserted and fixed in a receiving space 21 by penetrating one side of the carrier 20. It is preferred that an outer sleeve 45 of the whip antenna 40 can be fixed in the receiving space 21 in a bonding scheme.

The second antenna emitter 50 integrally extends from the first antenna emitter 30 to be electrically connected to a fixed outer sleeve 45 of the whip antenna 40.

That is, the second antenna emitter 50 can be formed by engaging an extension line 51 with the outer sleeve 45. The extension line 51 integrally extends from one side of the antenna emitter 30.

Meanwhile, a first power supply line 31 is provided at one side of the carrier 20 and electrically connects the first antenna emitter 30 to a first power supply pad 11. The first power supply pad 11 is provided on the main circuit board 10. Moreover, a second power supply line 41 is spaced apart from the first power line 31 and the first antenna emitter 30 through one side and an upper surface of the carrier 20. The second power supply line 41 electrically connects the fixed outer sleeve 45 of the whip antenna 40 to the second power supply pad 13, which is provided on the main circuit board 10.

The first and second power supply lines 31 and 41 may be formed of a plate of a metal material being the same material as that of the first antenna emitter 30.

Referring to FIG. 4, FIG. 5, and FIG. 7a, the first and second power supply lines 31 and 41 may elastically contact with, to be electrically connected to, the first and second power pads 11 and 13 by first and second elastic pins 31a and 41a of curved V shape, respectively. The first and second elastic pins 31a and 41a may be made by a certain shape available to be electrically connected to the first and second power supply pads 11 and 13 besides the V shape.

Accordingly, upon receiving a communication signal, the communication signal is transmitted to the first power supply pad 11 through the first antenna emitter 30, the first power supply line 31, and the first elastic pin 31a, and is finally transmitted to a communication module of the main circuit board 10.

When transmitting a communication signal, it is emitted to a space through the first antenna emitter 30 via a path opposite to a reception path.

Referring to FIG. 4 and FIG. 5, when the whip antenna 40 is inserted into the carrier 20, it is installed to be spaced apart from the main circuit board 10 to the largest degree. That is, it is preferred that the whip antenna 40 is installed adjacent to an uppermost surface of the carrier 20 to be spaced apart from the main circuit board 10 engaging with a lower surface of the carrier 20. This minimizes electromagnetic interference between the main circuit board 10 and the whip antenna 40 for easy communication.

The first antenna emitter 30 is a monopole antenna in which the number of the first power supply line 31 is one. The first antenna emitter 30 may engage with a ground line (not shown) to become a Planar Inverted F Antenna (PIFA). The ground line may be connected to a ground plate (not shown) of a main circuit board.

Furthermore, the first antenna emitter 30 may be a mobile communication antenna capable of receiving a high band frequency domain.

For example, Code Division Multiple Access (CDMA) scheme 1.8 GHz band can be used as the high band frequency.

Referring to FIG. 4, FIG. 5, and FIG. 6a, connection between the extension line 51 and the outer sleeve 45 of the second antenna emitter 50 is achieved by a first connection pin 53.

The connection pin 53 is made by conductive and elastic materials of a ‘ [symbol] ’ shape, and may perform the same functions as that of the first and second elastic pins 31a and 41a.

The first connection pin 53 contacts with the outer sleeve 45 electrically and elastically through a first through hole 23 formed penetrating an upper surface of the carrier 20 to expose the outer sleeve 45. The first connection pin 53 can be integrally curved and formed on the extension line 51.

As illustrated previously, the extension line 51 and the outer sleeve 45 are connected by the first connection pin 53 to form the second antenna emitter 50.

Moreover, in the second antenna emitter 50, the outer sleeve 45 is formed to be longer than the first antenna emitter 30. In addition, when the whip antenna 40 is completely folded, the second antenna emitter 50 acts as a monopole antenna.

Accordingly, the second antenna emitter 50 may be a mobile communication antenna capable of receiving a low band frequency domain.

For example, a CDMA scheme 800 MHz domain band can be used as the low band frequency.

Referring to FIG. 4, FIG. 5, and FIG. 6b, connection between the fixed outer sleeve 45 of the whip antenna 40 and the power supply line 41 is achieved by a second connection pin 43 of a conductive material.

The second connection pin 43 is made by a conductive and material of a half circle shape and may perform functions of the first and second elastic pins 31a and 41a. The second connection pin 43 contacts with the outer sleeve 45 electrically and elastically through a second through hole 25 formed penetrating an upper surface of the carrier 20 to expose the outer sleeve 45.

Furthermore, the second connection pin 43 can be integrally curved and formed on the second power supply line 41.

The first and second connection pins 53 and 43 can be substituted by each other. All types of a structure that performs electrical contact may be used as the first and second connection pins 53 and 43.

The first and second connection pins 53 and 43 and the first and second elastic pins 31a and 41a can be substituted by each other.

As described earlier, when the second power supply line 41 is connected by the second connection pin 43 and the whip antenna 40 is completely extended, it can act as a broadcasting antenna. Namely, referring to FIG. 4, FIG. 5, and FIG. 7b, an inner sleeve 46 inserted or extended into or from an outer sleeve 45 of the whip antenna 40 can act as a broadcasting antenna when a latch 48 protruding from a lower periphery of the inner sleeve 46 is hooked to a protrusion 47 formed at an upper inner periphery of the outer sleeve 45.

A broadcasting receiving signal received through a whip antenna 40 of a broadcasting receiving path is transferred to the second power supply pad 13 through the second power supply line 41 and the second elastic pin 41a and then transferred to a broadcasting module of the main circuit board 10.

The whip antenna 40 may have a lower band than the second antenna emitter 50, and receive one frequency domain among Terrestrial Digital Multimedia Broadcasting (DMB), Digital Video Broadcasting-Handheld (DVB-H), Forward Link Only (Media FLO), and Advanced Television Systems Committee-Mobile/Handheld (ATSC-M/H).

Because the whip antenna 40 is electrically connected to the first antenna emitter 30 through the second antenna emitter 50, it may use the first antenna emitter 30 as a length component. Accordingly, the whip antenna 40 may reduce the length corresponding to that of the first antenna emitter 30.

Consequently, the whip antenna 40 may have one stage of an inner sleeve 46 inserted and extended into and from the outer sleeve 45.

The following is a detailed description of an operation of a multi-band antenna device.

First, while a portable terminal is performing voice or video communication through a first antenna emitter 30 receiving a high band frequency domain, when it moves to a low band frequency domain, it can continue voice or image communication through a second antenna emitter 50.

That is, when a portable terminal performs a mobile call in a zone that includes a base station using high band frequency communication, it transmits and receives frequencies by a first antenna emitter 30 to enable the call.

Next, when a portable terminal performs a mobile call in a zone beyond a base station using high band frequency communication, namely with a low band frequency, it transmits and receives frequencies by the second antenna emitter 50 to enable the call.

In an reverse situation, namely, when the portable terminal moves from a low band to a high band, it can transmit and receive frequencies in the same manner.

In the meantime, when a user watches the mobile broadcast regardless of a zone using the first antenna emitter 30 or a zone using the second antenna emitter 50, the broadcast can be received by completely extending an internal whip antenna 40. That is, the user can watch broadcast by extending the whip antenna until a latch 48 of an inner sleeve 46 of the whip antenna 40 is hooked and fixed to a protrusion 47 of the outer sleeve 45. A broadcast service, for example, a TDMB broadcast service is prepared regardless of the high band base station or a low band base station.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A multi-band antenna apparatus of a portable terminal, comprising:
a carrier configured to engage with a main circuit board of the portable terminal;
a first antenna emitter provided at one side of the carrier;
a whip antenna including an outer sleeve provided inside the carrier;
a second antenna emitter electrically connected to an extension line integrally extended from the first antenna emitter and the outer sleeve of the whip antenna fixed in the carrier;
a first power supply line configured to electrically connect a first power supply pad provided at the main circuit board to the first antenna emitter; and
a second power supply line configured to electrically connect the outer sleeve of the whip antenna to a second power supply pad provided at the main circuit board.

2. The multi-band antenna apparatus of claim 1, wherein the extension line of the first antenna emitter and the outer sleeve of the whip antenna are electrically connected to each other by a first connection pin formed of a conductive and elastic material.

3. The multi-band antenna apparatus of claim 1, wherein the first antenna emitter is one of a monopole antenna or a Planar Inverted F Antenna (PIFA).

4. The multi-band antenna apparatus of claim 1, wherein the outer sleeve of the whip antenna and the second power supply line are electrically connected to each other by a second connection pin formed of a conductive and elastic material.

5. The multi-band antenna apparatus of claim 1, wherein the first antenna emitter is a mobile communication antenna capable of receiving a high band frequency domain.

6. The multi-band antenna apparatus of claim 1, wherein the outer sleeve of the whip antenna has a length longer than that of the first antenna emitter.

7. The multi-band antenna apparatus of claim 1, wherein the second antenna emitter is a mobile communication antenna capable of receiving a low band frequency when the whip antenna is completely in the outer sleeve.

8. The multi-band antenna apparatus of claim 1, wherein the whip antenna operates as a broadcasting antenna when the whip antenna is completely extended.

9. The multi-band antenna apparatus of claim 8, wherein the broadcasting antenna receives one frequency domain among Terrestrial Digital Multimedia Broadcasting (DMB), Digital Video Broadcasting-Handheld (DVB-H), Forward Link Only (Media FLO), and Advanced Television Systems Committee-Mobile/Handheld (ATSC-M/H).

10. The multi-band antenna apparatus of claim 1, wherein the whip antenna is spaced apart from the main circuit board to the maximum extent.

11. The multi-band antenna apparatus of claim 1, wherein the whip antenna uses the first antenna emitter as a length component.

12. The multi-band antenna apparatus of claim 10, wherein the whip antenna includes one stage of an inner sleeve that is inserted into and extended from the outer sleeve.

13. The multi-band antenna apparatus of claim 1, wherein the first and second power supply lines and the first and second power supply pads of the main circuit board are electrically connected to each other by first and second connection pins, respectively.

14. A multi-band antenna apparatus comprising:
a first antenna emitter configured to receive a high band frequency domain;
a whip antenna comprising an outer sleeve portion and an inner sleeve portion, the whip antenna configured to act as a broadcasting antenna when the inner sleeve portion is extended from the outer sleeve; and
a second antenna emitter formed by electrically extending from the first antenna emitter to the outer sleeve of the whip antenna, the second antenna emitter configured to receive a low band frequency domain.

15. The apparatus of claim 14, wherein the first antenna emitter is one of a monopole antenna or a Planar Inverted F Antenna (PIFA).

16. The apparatus of claim 14, wherein the whip antenna uses the first antenna emitter as a length component.

17. The apparatus of claim 14, further comprising a carrier configured to engage with a main circuit board of the portable terminal, wherein the whip antenna is provided inside the carrier.

18. The apparatus of claim 17, wherein the first antenna emitter is provided at one side of the carrier.

19. The apparatus of claim 14, further comprising:
a first power supply line configured to electrically connect a first power supply pad provided at the main circuit board to the first antenna emitter; and
a second power supply line configured to electrically connect the outer sleeve of the whip antenna to a second power supply pad provided at the main circuit board.

20. The apparatus of claim 19, further comprising:
a first connection pin formed of a conductive and elastic material and configured to electrically connect the first antenna emitter and the outer sleeve of the whip antenna; and
a second connection pin formed of the conductive and elastic material and configured to electrically connect the second power supply line and the outer sleeve of the whip antenna.
